(19) United States
(12) Patent Application Publication
(10) Pub. No.: US 2022/0141014 A1
(43) Pub. Date: May 5, 2022

(54) STORING SECRET DATA ON A BLOCKCHAIN

(71) Applicant: PolySign, Inc., Oakland, CA (US)

(72) Inventors: Arthur Britto, San Francisco, CA (US); David Schwartz, Tiburon, CA (US); Zack Brunson, Hayward, CA (US); Lukas Stille, Oakland, CA (US); Arun Velagapalli, Milpitas, CA (US); Nitin Mahendru, San Jose, CA (US); Kimon Papahadjopoulos, Oakland, CA (US)

(21) Appl. No.: 17/090,363

(22) Filed: Nov. 5, 2020

(51) Int. Cl. H04L 9/08; H04L 9/06; H04L 9/30; H04L 9/32

(52) U.S. Cl. CPC H04L 9/0894; H04L 9/0637; H04L 2209/38; H04L 9/32; H04L 9/3073

(57) ABSTRACT

Systems, methods, and devices are provided that allow for high-availability, redundant, cryptographically secure storage of secret data and other data on a blockchain. In an embodiment, a plurality of shards of secret data are received from a user and encrypted with shard manager public keys. The encrypted shards are stored on an authoritative blockchain, allowing for secure storage and use of the secret data by the owner and/or the blockchain.

### BACKGROUND

Blockchains are an increasingly popular means of storing various types of data, including transactional data such as movement of a resource from one entity to another. For example, blockchains are often used to store transactions associated with one or more cryptocurrencies, where each entity involved in the transaction has a cryptocurrency address or similar construct that stores amounts of a cryptocurrency owned by the entity. Such an address typically operates through use of one or more secrets that provide control of the address. For example, the cryptocurrency address may have a public portion that allows any entity to send value to the wallet, and one or more cryptographically-secure keys that allow only the key owner to make changes to operation of the address, send value out of the address to another address, and the like.

### BRIEF DESCRIPTION OF THE DRAWINGS

FIG. 1 shows an example process for initiating an authoritative blockchain using a bootstrap process as disclosed herein.

FIG. 2 shows an example process for modifying a policy in an authoritative blockchain as disclosed herein.

FIG. 3A shows an example process for storing an external secret on an authoritative blockchain as disclosed herein.

FIG. 3B shows a process for retrieving a stored external secret corresponding to the process shown in FIG. 3A.

FIG. 4A shows an example process for storing an external secret in an authoritative blockchain as disclosed herein.

FIG. 4B shows an example process for recovering a key stored via the process of FIG. 4A.

### DETAILED DESCRIPTION

Although blockchains are often used in conjunction with systems that make use of user-known secrets, secrets themselves cannot be stored securely on a conventional blockchain in a manner that would allow the secret to remain under control of the secret owner but still be available to the secret owner without requiring another secret, such as a separate encryption key, which then would need to be held by the secret owner instead of the original secret. As such, there is a need for a blockchain system and process as disclosed herein, which allows for storage of a secret on the blockchain.

The lack of a means of storing secrets on a blockchain often results in a division of responsibilities when data including user secrets is used in conjunction with the blockchain system. For example, in a conventional blockchain system, each user is responsible for keeping their own secrets off the blockchain to maintain control of them. For example, where the secret is a secure key that provides access to, and control over, a cryptocurrency addresses, the user is made responsible for keeping the secret off the blockchain while using the blockchain to store transactions associated with the address. Such an arrangement may be undesirable for a number of reasons. For example, if a user loses the secret, they generally also lose access to the cryptocurrency address and any cryptocurrency assets stored in it. This separation of responsibility is often necessary to protect the user secrets due to the structure of the blockchain system itself. For example, some blockchain systems have operators that have the ability to inspect and potentially to tamper with the operation of the blockchain. Such a blockchain is not capable of storing information that is secret from the operator. As another example, in some blockchain systems, validators in the system can modify the blockchain software itself, meaning that any validator could modify any secret-keeping functionality to export the secret with or without knowledge of the secret owner.

Embodiments disclosed herein may prevent changes to the operation of systems and executable code used to perform mining or other validation operations, thereby making export of secret information stored on the blockchain impossible. In contrast to the conventional block chain systems disclosed previously, blockchain operators cannot independently modify the validating code in a non-compliant manner.

Accordingly, in contrast to known blockchain systems, embodiments disclosed herein may allow for secure storage of information that is encrypted by secrets that are not known by either users or operators of the blockchain system.

Two types of secrets may be considered in the following discussion. User secrets may include secrets that a blockchain system as disclosed herein generates and holds on behalf of a user of the system (an “end user”). For example, the system may generate a number that can be used as a cryptographic secret, such as an encryption and/or decryption key. Alternatively or in addition, a system as disclosed herein may receive an external secret from a user using one or more Hardware Security Modules (HSMs) that allow for installation and execution of code within the HSM. Such HSMs typically provide tamper-proof computing and/or computer-readable storage that can be secured through a combination of software and hardware elements. Examples of suitable HSM hardware may include those from Yubico of Palo Alto, Calif., nCipher Security of Cambridge, and Utimaco of Aachen, Germany, though any HSM device known in the art may be used that is capable of performing the functions disclosed herein. Unless specified otherwise, an “HSM” used in conjunction with an authoritative blockchain system as disclosed herein refers to an HSM that can receive and execute cryptographically-signed code within the secure boundaries of the HSM.

To store an external secret as disclosed herein, one or more HSMs may encrypt the external secret using a public/private key pair. The HSMs may then export the secret in encrypted form by, for example, encrypting the secret using a public key of a recipient system such as another HSM or a blockchain. Presuming the recipient system is also secure and the correct public key is securely provided to the encrypting device, the secret is never exposed but can now be stored by the recipient system. Exporting the secret may be secured using multi-signature and authentication policies.

Another type of secret that may be considered is a system secret, which refers to a secret that the blockchain system holds on its own behalf that is used to secure user secrets. In some embodiments, internally-generated system secrets may be exported in encrypted form for disaster recovery. In this context, “recovery” of the secret includes a mechanism to expose the secret, such as in a situation where the user has lost his own secret due to a disaster. As another example, secrets may be exported only for restoration of HSMs in the system, but not for recovery of individual secrets. Such a configuration may require a validator network made up of entities that are trusted not to collude to defeat the security of the system.

Embodiments disclosed herein may be implemented on a computing system as disclosed, for example, in U.S. patent application Ser. No. 16/359,055 filed Mar. 20, 2019, the disclosure of which is incorporated by reference in its entirety.

Embodiments disclosed herein use a blockchain embodied in an ordered list of linked blocks. In contrast to purely transactional blockchains such as those used to track Bitcoin and other similar cryptocurrency transactions, a blockchain as disclosed herein may store both transactions and policies in the ordered list, where the policies control actions that are possible on or with respect to the blockchain. Modification of the policies themselves also may be controlled through the transactions and policies in the ordered list. Such a blockchain may be referred to herein as an “authoritative blockchain.” As disclosed herein, an authoritative blockchain may provide advantages over conventional transactional blockchains as well as permissionless and public blockchains that rely on policies and restrictions that are external to the blockchain itself to insure validity and trustworthiness of transactions or other data stored on the blockchain.

In an authoritative blockchain as disclosed herein, the policies stored on the blockchain may determine which actions are taken when a particular transaction or type of transaction is stored on the blockchain. For example, a policy may specify that a particular transaction or type of transaction requires a minimum number of approvers to approve the transaction before it takes place and is included on the blockchain. Various types of transactions may be considered for an authoritative blockchain as disclosed herein. Policies may be modified by submitting transactions to the blockchain.

As used herein, a “valid transaction” is one that the system accepts for inclusion in the blockchain. In some cases, a transaction may incur a fee or other cost to one or more of the parties to the transaction at the point it becomes a valid transaction. The use of a fee may prevent intentional and/or inadvertent transaction “spamming” in which a large number of transactions are submitted to the blockchain, such as to reduce the efficiency or operability of the blockchain.

As used herein, an “approved transaction” is one that satisfies the relevant approval criteria of policies included on the blockchain. Although in some embodiments any “valid” transactions may be included on the blockchain, in some embodiments only “approved” transactions are executed such that the prescribed action determined by the policy or policies is taken.

Embodiments disclosed herein may restrict policies defined on an authoritative blockchain such that new policies and changes to existing policies may be implemented only by submitting one or more transactions to the blockchain. Thus, the same verification and approval procedures used for other transactions may be applied to the policies that govern behavior of the blockchain themselves. Consistent with the definitions above, policies may be “valid” without being “approved”, or may be both valid and approved. For example, a policy may be submitted to the blockchain that meets basic criteria for defining a policy within the blockchain, such as identifying a type of user and a type of behavior that is allowed or prohibited, a threshold for approving a transaction, or the like. However, the policy may not be “approved” until it passes the currently-defined approval process for any transaction submitted to the blockchain, consistent with any currently-defined policies on the blockchain. For example, existing policies may require a plurality of a defined group of approvers to approve a new policy before it is implemented on the blockchain as an active policy.

Initial policies and permissions of an authoritative blockchain as disclosed herein may be defined via a special “bootstrap” transaction that is required as the first transaction accepted by the blockchain and not accepted subsequently. An example bootstrap transaction and process is described in further detail below.

Notably, embodiments of an authoritative blockchain as disclosed herein may operate on and within a secure computing environment. In contrast to a conventional environment in which policies may be enforced only through, for example, human-enforced rules and procedures, this secure computing environment may implement policies as previously disclosed using restraints enforced by computing hardware that cannot be changed by human operators without using the appropriate computer-enforced mechanism, such as policy modifications as described above. In a secure computing environment as disclosed herein, the business logic that accepts new transactions for entry on the blockchain (whether valid and/or approved) may be implemented within a secure computing boundary, such as on one or more HSMs. Typically the executable code stored in and executed by the HSM is protected from the introduction of unaudited through the use of a quorum that may include multiple auditors. Each HSM may accept new business logic embodied in new or modified executable code only if it is properly signed with the correct digital signature or signatures. In some embodiments, new code may be signed only after a successful code audit. For example, the policy may require a proposed modification to be signed by a registered code auditor. Such restrictions may be enforced by the HSM hardware itself, further reducing the possibility of tampering. Multiple HSMs may be used for additional security and/or redundancy. For example, multiple HSMs may implement a consensus network or similar algorithm to decide the next transaction that should be included in the authoritative blockchain.

HSMs as disclosed herein may be obtained by and/or operated by “validator” operators as previously disclosed, which may be entities that have been vetted by one or more owners or other controlling entities of the blockchain system to be reliable and independent counterparties. However, the use of multiple HSMs may provide protection and security against failure, error, or fraud related to one or more HSMs as disclosed herein. Validator entities maintain the HSMs and make them available to the authoritative blockchain system. As previously disclosed, validators cannot control, access, or modify the software running on the HSMs because each HSM will only execute software that has been securely audited and cryptographically approved, which requires appropriate authorization according to policies of the authoritative blockchain as previously disclosed. Notably, validator operators of the HSMs do not have access to secrets stored on the HSMs and even in the case where one or more operators or HSMs are compromised or fails, as long as a quorum of operators and HSMs are available then all secrets are securely preserved as previously disclosed.

In addition to using HSMs, embodiments disclosed herein may structure the policies in the system such that data operated on by the HSMs cannot be examined by operators of the HSMs or developers of the audited code implemented on the HSMs other than allowed by the policies. This is a consequence of implementing the control policies within the HSM- and policy-controlled system as previously disclosed, where the policies themselves are subject to the same controls as any other transaction in the system.

As previously disclosed, some operations, policies, and arrangements may use authorizations of one or more entities, such as users of the authoritative blockchain system, to determine whether a transaction is verified and should occur. These users may be individual people, groups (which may have their own internal policies and procedures), legal constructs such as corporations that act through one or more human or other users, automated or semi-automated computer systems, or combinations thereof. Each user may be registered in the authoritative blockchain system as described in further detail herein. A digital signature for a user may be registered with and stored in the blockchain, such as via a defined transaction type. Each user may use their digital signature to sign a potential or proposed transaction and thereby indicate the user's approval of the transaction, which process may be referred to as “authorization” or “authorizing the transaction.” The blockchain itself uses signatures generated by individual HSMs that operate the blockchain, thereby providing end-to-end hardware security for the blockchain itself. Thus, even if intervening software is compromised, the blockchain can still operate with integrity due to the requirement for cryptographic proof before transactions take place.

As previously disclosed, in some embodiments a policy may require a quorum of registered users or a particular type of registered user for an action, such as approving a transaction, to take place. For example, a policy may specify that four out of five users (or any other portion up to and including all) out of a particular group or type of user must authorize the transaction before it is approved. Different types of objects or transactions may require different numbers of authorizations to proceed. For example, balances, accounts, quorums, and policy documents may have different numbers of authorizations from registered users, which may be specified by policies implemented in the authoritative blockchain as previously disclosed. Since a user's digital signature is registered with the system, HSMs may retrieve each user's prior signature to confirm that a particular signature authorizing a transaction is valid. Accordingly, any data stored in the blockchain may be considered secure and trusted within the system and therefore available to the logic implemented in the HSMs.

Examples of policies that may be implemented in an authoritative blockchain as disclosed herein include a policy that allows a single registered user of a certain type, or from a specified list of users or user roles, to approve less sensitive transactions. For example, in a system where transactions may include transfers of monetary units or other items of value, a transfer under a certain threshold (e.g., total value less than $100, $1,000, $10,000, or any other threshold), whereas transactions with a total value over that amount may require a quorum of such users, such as 3 of 5 users. Similar policies may be implemented for non-financial transactions. For example, a transaction that accesses or affects multiple user accounts or user information may require a different number of appropriate users to approve the transaction compared to a transaction that only accesses or affects a single user account. More generally, policies can describe any suitable combination of different rules and requirements. Other examples of criteria that may be used in defining a policy include a time delay that must occur after approval before a transaction can be executed, the total value involved in the transaction, a voting weight assigned to individuals associated with a possible transaction, and the like.

In some embodiments, cryptographic secrets may be created, stored, and imported in the secure boundary of an authoritative blockchain system as disclosed herein. To create a secret, a random number may be generated within an HSM of the system. The random number may itself be the secret, or it may be used to generate, encrypt, or otherwise create a secret using any suitable cryptographic techniques. In some cases, a secret may be created jointly by multiple HSMs, for example using multi-party computation (MPC) techniques and sharded so that no single HSM within the group stores the entire secret. Continuing the previous examples, where multiple HSMs are used to implement an authoritative blockchain, some or all of the blockchain HSMs may be used to generate such a secret. Such arrangements may provide additional security and/or redundancy for the secret. If one or more shards are lost, the secret may still be re-generated if a sufficient number of remaining shards are available. Similarly, if one or more shards are compromised, the secret may still be protected as long as not enough shards are compromised to reconstruct the secret. Each HSM may store the associated portion of the secret in a blockchain transaction, which may be signed by a private key of the HSM. This may provide a secure form of backup for the secret. Access to the secret may be guarded not only by the sharding and encryption of the secret but also by other policy restrictions on the blockchain itself.

Notably, regardless of whether the secret is sharded or a single secret, the secret will not be known or otherwise available to any person, computing system, or other entity in unencrypted form outside the HSM(s), but still may be used within the authoritative blockchain according to the policies implemented in the blockchain. For example, a set of policies may allow the secret to be used to create a digital asset address and/or sign a transaction related to the address upon receipt of transactions showing approval of a quorum of predefined entities that are authorized by the policies to use the secret. In response, the HSM(s) may automatically decrypt the secret (or shards of the secret) and use it to sign the indicated transaction without revealing the secret outside the secure computing environment of the HSM(s). As previously indicated, because the system is controlled by policies that are implemented in the authoritative blockchain system, no operators, developers, hosting facility or other host entities, administrators, or other individual entities may control use and security of the secret, other than as specified by the policies. Further, as previously disclosed, the policies may only be modified via transactions submitted to the blockchain and thus cannot be arbitrarily changed to allow access by an entity that otherwise would not have access.

Alternatively or in addition to storing secrets generated within the secure computing environment of an authoritative blockchain, embodiments disclosed herein may “import” secrets generated elsewhere. For example, registered users or other secure systems may provide a secret to be imported for purposes such as backing up secrets so that they can be securely sent, stored, and/or recovered by registered users; to provide cryptographic control of, or access to, other secure systems; to securely transfer secrets to other systems or entities when certain criteria are met such as to implement a “deadman's switch”; or any other suitable use where secure storage of a secret is desirable, especially without developers, administrators, or other unauthorized entities to have access to the secret even where they may have access to certain parts of the system that stores the secret. Specific examples of such import techniques are described in further detail below. Generally, a user may create a secret externally to the system, optionally shard the secret, and encrypt the secret or the shards with public key(s) of the HSM(s) of the system. The encrypted secret or shards may then be added to the blockchain using one or more appropriate transactions, after which use of, and access to, the secret or shards is controlled by policies as previously disclosed.

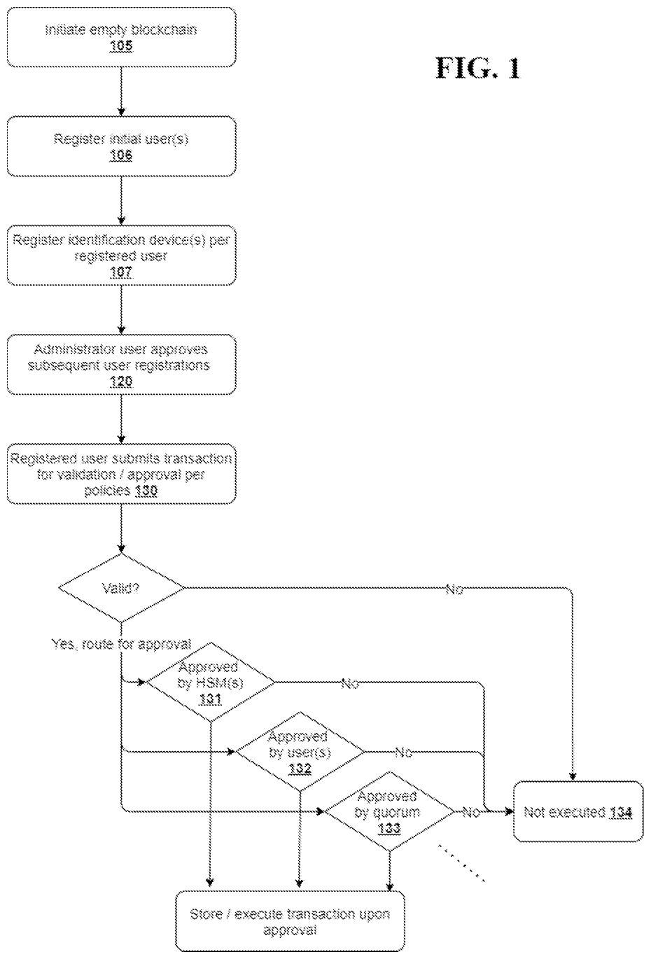

FIG. 1 shows an example process for initiating an authoritative blockchain using a bootstrap process. At 105, the system begins with an empty blockchain. This may be, for example, a data structure suitable for storing transactions of the blockchain with zero transactions initially stored. At this point, the only transaction allowed by the system as the first transaction is a special type of “bootstrap” transaction, which defines the initial permissions for users to execute additional transactions. Typically the bootstrap transaction will implement certain minimum actions, including registering one or more users at 106 and registering one or more identification devices for each registered user at 107, which are capable of identifying cryptographic proof of user approval of future transactions. For example, a physical device that implements the Fido2 protocol or similar may store a private key that cannot be extracted from the device, which can be associated with an individual user. To register the device, the public key is stored in the blockchain. Proof of the user's approval is then accomplished when the user uses the device to sign, for example, the hash of a transaction to be executed, which signature is then included in the transaction in the blockchain. The authoritative blockchain HSM may independently reconstruct the key parameters of the transaction (e.g., “value”, “to”, “from” parameters) and then confirm with the public key that the signature was generated using the private key of the user's device.

The initial users registered during the bootstrap process may be given “administrator” type permission on the system, i.e., they may have elevated privileges in the system compared to users that are registered later. These users also may be the only parties that can approve future transactions when the bootstrap transaction is completed, although future transactions can grant approval authority and/or other permissions to other users as previously disclosed. In some embodiments, while administrators may have the most permissions of any user in the system, their permissions still may be constrained to a limited range of activities, such as approving new users, elevating permission levels of existing users, or constraining users' administrative-level capabilities by, for example, adding a quorum requirement to some or all administrative activities, while still being prevented from taking more extensive actions such as rewriting the blockchain itself. Future transactions also may add other types of users and/or permissions to the system. New transaction types and/or other business objects may require more extensive modification than can be achieved through transactions and instead may require an update to the system software as previously disclosed. Generally business objects may include any item that is needed to implement logic flows within the system including, for example, users, devices, firms, vaults, and policies. Each business object also may have associated policies as previously disclosed, and a policy may itself be a business object. The associated policies may define permissions for the business object, rules on how the business object may be accessed or modified, and how one business object may relate to another.

At 120, one of the initially-registered “administrator” users may approve one or more other transactions that register one or more other users in the system. Such registration may include registration of associated devices that can identify the newly-added users to verify when those users approve transactions. Alternatively or in addition, some users may be registered that do not have permission to approve transactions themselves, but rather can only submit transactions for approval. More generally, newly-added users may have fewer permissions, or lower permission levels, than the initial administrative users. By way of example, a “firm” business object (representing a corporation or similar entity) may have one or more associated users who have permission to modify only the business object for that firm but not similar business objects for other firms. The new users also may not have permission to add additional new users. In some cases, even administrator-level users may not have permission to perform some actions with respect to other business objects or users. For example, an administrator may create a new “firm” and create one or more users that are associated with the firm, who may be given authority to approve transactions generated in the name of the firm via policy controls as previously disclosed. However, although the administrator user created the firm and associated other users, the administrator may have no ability to approve transactions generated in the name of the firm. As previously disclosed, the created user(s) may have no ability to add other users to the system. Each user, whether administrator or not, has a sphere of access within which they can perform various functions, and outside of which generally they have limited or no ability to perform functions in the system. More generally any specific, limited combination of permissions may be assigned to a new user, and if a new user has permission to add additional new users, they also may be able to assign any combination of permissions available within the system to those additional new users. In some embodiments, a user that has permission to add new users may be able to assign permissions up to and/or including permissions equivalent to their own, but not higher or more expansive permissions. Again, any desired combination of permissions may be defined for each user and/or each user added by a user. However, in specific implementations it typically will be desirable to limit the set of permissions that can be assigned to a new or existing user.

At 130, any of the users registered with the system may submit and/or approve transactions as previously disclosed. For example, a first user may submit a transaction for approval. If the transaction is valid, depending on the relevant policies implemented on the system, the transaction may be approved by the system itself (via the HSMs) at 131, or it may be approved by a single second user (such as where the importance, sensitivity, or value of the transaction is below a threshold as previously disclosed) at 132, or it may be approved by a quorum of users at 133 as previously disclosed. If the transaction is not approved, it may be recorded in the blockchain at 134 but not executed. For example, where a transaction that describes a transfer of funds is not approved by the requisite quorum of users, the blockchain may include a record that the transaction was submitted but the funds may not be transferred as described in the transaction.

As previously disclosed, at 133 a quorum of users (e.g., 1 of 1, 2 of 3, 3 of 5 or generally any X of Y as specified by the relevant policy) may need to approve a transaction. Each user may approve the transaction by signing the transaction with a previously-registered hardware device as previously disclosed. In embodiments where user identities are verified as part of the approval process, one or more “verifier firms” may have a quorum of its own verifier entities verify the information of each quorum approval and the identity of the approvers. As a specific example, each approver may submit an attestation video that is reviewed and verified against the associated transaction. In this embodiment, an approving user may create a video of themselves in which they identify themselves and describe the transaction being approved. The verifier may compare this video to an initial video created when the approving user was registered in the system to confirm the approving user's identity.

Alternatively or in addition, the transaction, the signed transaction, and/or the approval videos may be provided to the authoritative blockchain HSMs. The blockchain already stores a record of the user's public keys as previously disclosed (such as by storing public keys associated with private keys of hardware devices owned by each user) so the HSMs can determine whether the submitted signatures were created with each user's device with cryptographic certainty. The system also may verify the transaction against one or more policies that govern the transaction to determine whether the transaction is allowed, how many approvals are necessary, and by whom the transaction must be approved.

Notably, the authoritative blockchain as disclosed herein controls assignment of permissions within the secure computing environment provided by the HSMs and thus allows the entire history of user registrations and grants of permission to be audited. Since each assignment of permissions is made via a transaction submitted to the blockchain, an auditor can trace how and when any specific permission was granted to any user by tracing the appropriate transactions in the blockchain. Notably, it is not necessary for the HSMs to store the entire blockchain to operate the system or to provide such auditing functionality, since they only need the latest block of the blockchain to validate the state of the system, including all business objects which are stored in an index ordered Merkle tree (IOMT). As will be understood by one of the skills in the art, in this structure each node in the tree contains the hash of its two children, up to the root node (“root of IOMT”). Accordingly any change to any leaf object in the tree will cause a change to the root of IOMT. The authoritative blockchain HSMs then may store only the root of IOMT, so that when the HSM is provided with a “proof” that includes a set of leaves included in the transaction and all nodes which connect those leaves to the root of the IOMT, the HSM may calculate the expected value of each node up to the root of the IOMT without requiring the entire tree. If the calculated expected hash matches the known root of IOMT, tree is known to be valid. Since the leaves encode the state of the system (where the tree includes user nodes, device nodes, policy nodes, etc.), the HSM can verify that the state is correct.

Once the subset of leaves has been proven, a proposed change to the tree may be provided to the HSM. Specifically, the change is the transaction that the sender desires to execute and the resulting root of IOMT after execution. The HSM may determine what changes the proposed transaction would make to the tree and whether a particular transaction is allowed or not in the context of the existing tree, which has already been proven. If the transaction is allowed and the HSM determines that the root of IOMT will change as proposed in the transaction, the HSM makes the change and updates the root of IOMT. In some embodiments, the system may require multiple independent HSMs, such as a majority of independent HSMs in the system, to reach the same conclusion and update their associates root of IOMT es via a consensus protocol.

Such structures may be important to achieve acceptable performance of the system, since HSMs may have relatively limited computing resources compared to those that would be required to re-validate the entire blockchain.

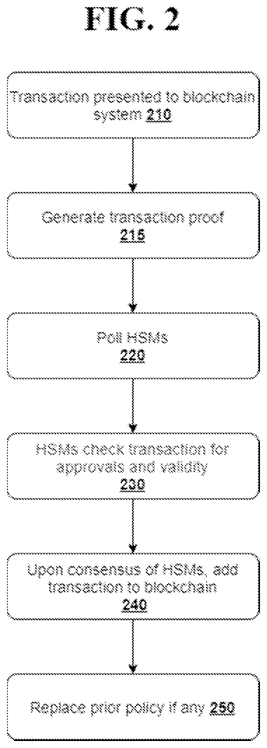

FIG. 2 shows an example process for modifying a policy in an authoritative blockchain as disclosed herein. The process may be implemented at any point after an initial bootstrap process as described with respect to FIG. 1 and presumes that at least one policy has already been placed into the blockchain.

At 210, a transaction is presented to the blockchain that defines a change to one or more policies. When the transaction is presented, at 215 the transaction is packaged into a “transaction proof” as previously disclosed, i.e., a data structure that contains a list of all relevant business objects needed to prove the validity of the transaction. Examples of relevant objects may include any relevant policies, any users who approved the transaction, and the transaction itself. For example, where an existing policy is being modified, the transaction may be a type such as “set policy” that is defined as a policy modification transaction type in the system as well as the parameters to be modified.

At 220, the HSMs of the system may be polled and, at 230, the HSMs may check the transaction for validity as previously disclosed. If the transaction is valid and there is consensus among the appropriate HSMs, then the transaction is executed at 240. As part of the validation check, the policy defined in the transaction may be analyzed to determine if it is a valid policy against an identified set of logical and business rules. For example, a policy that requires no approvals like create user is not a valid policy (except during a bootstrap transaction as previously disclosed). Approvers identified in the transaction also may be verified as being in the list of approvers for the policy; if no valid approvers are listed, the transaction is not considered valid. If the transaction proposes to modify a policy, the new policy also may be checked for validity as part of the transaction verification.

When the valid, approved transaction is added, at 250 the new policy may be added to the system and, if it is a modification to an existing policy, the new policy overwrites the old policy. Any subsequent transactions governed by the policy will use the requirements of the new policy. As a specific example, a transaction may be processed that increases the number of approvals needed for a certain type of transaction. After processing the transaction that includes the policy change (presuming it is found to be valid and approved), any transaction of that type will only be executed if the higher number of approvals are received. Since the policies and policy changes are stored on the blockchain, the system can determine the current policy requirements at any given point in time by determining the most recent versions of each policy that apply to a given transaction.

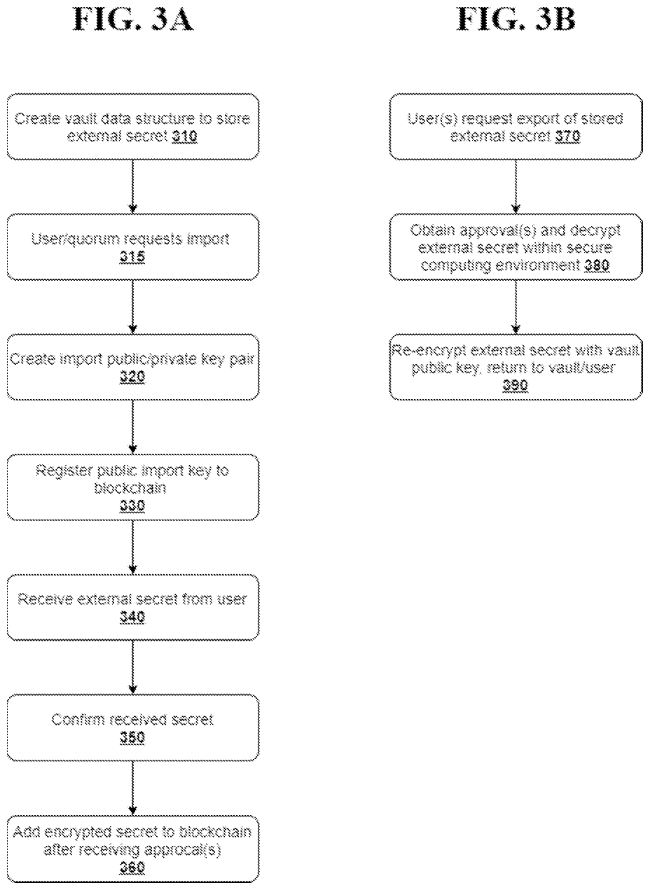

FIG. 3A shows an example process for storing an external secret on the blockchain. This example presumes that the blockchain has already been created via a bootstrap process and users have been registered as previously disclosed. At 310, a data structure is created to store the external secret. The structure may be a cryptographic vault business object, which may itself be defined and/or secured by a separate secret. At 315, a user or a quorum of users of the vault (depending on the vault ownership and structure) may decide to import a secret into the vault, for example via an “import secret” transaction type. Such a transaction may be processed using the quorum approval processes as previously disclosed.

At 320, a temporary public/private “import key pair” is created. Preferably, this is a single-use key pair. Typically the import key pair will be created by the owner of the external secret that is to be imported, which may be the administrator or owner of the vault. At 330, the public import key is registered to the blockchain as previously disclosed with regard to user public keys.

At 340, the secret to be imported may be provided by a user, such as by generating the secret on a secure device, and encrypted with the import private key the public portion of which was registered at 330. The encrypted secret is included in a designated transaction type (e.g., “store remote secret”) and submitted to the validator network to further submit to the blockchain. The submission may include appropriate approvals from other members of the vault. More generally, as previously disclosed, one or more policies implemented on the authoritative blockchain system may specify the manner in which the external secret is to be provided, the number and nature of approvals needed, and any other relevant parameters for the transaction.

In some embodiments, at 350 the validator nodes may confirm that the received imported secret is correctly decrypted by verifying the signature on the received secret, i.e., by having the sender sign something that the HSM(s) can reconstruct with the associated private key, and then validating that signature with the public key of the secret being imported.

At 360, if the requisite number or quorum of validators approve the transaction, the encrypted secret is stored on the blockchain. At this point the transaction is included in the blockchain ledger and the external secret is safely stored. The imported secret may be stored as a domain object to allow for more efficient lookup and retrieval within the system.

FIG. 3B shows a corresponding process for retrieving a stored external secret. At 370, a user or a quorum of users of the vault decide to export the stored external secret from the vault and generate a “retrieve secret” type transaction. As needed based on existing policies and the structure of the vault, sufficient approvals from other owners or members of the vault may be included in the transaction that is submitted to the blockchain.

If the approvals are sufficient, at 380 the system decrypts the encrypted secret inside a secure computing environment such as one or more HSMs as previously disclosed.

At 390 the secret is re-encrypted with a public key of the vault and returned to the requesting user, who may use a corresponding vault private key to decrypt the secret. In an embodiment where a temporary secret is used, the vault owner(s) may generate a new secret as was done to store the secret initially, and the new secret then may be used to decrypt the stored secret. In this arrangement the vault owner need not remember a long-term private key; rather, they create a new temporary key each time.

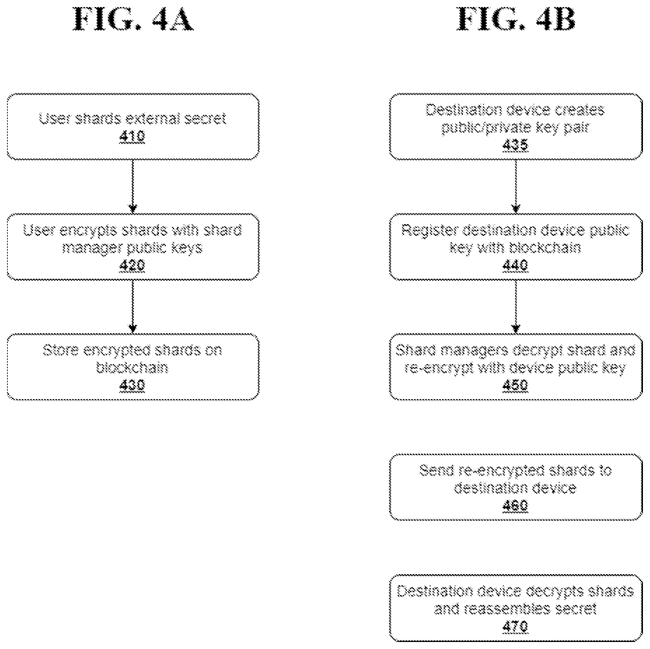

The processes shown in FIGS. 3A-3B may be sufficient to store a secret on an authoritative blockchain as disclosed herein. However, other processes may be used such as where additional security and/or redundancy is desired, or where the authoritative blockchain is configured to use multiple HSMs as previously disclosed. FIG. 4A shows another example process for storing an external secret in an authoritative blockchain as disclosed herein. Such processes may be useful, for example, to provide backup of legacy secrets; to provide signing functionality using a legacy secret using an authoritative blockchain that may provide improved security and/or redundancy compared to the legacy system that initially generated the secret; and/or to allow other parties to sign using the authoritative blockchain system.

In this example, the blockchain system has multiple shard manager HSMs, each of which has an associated shard manager public/private key pair. At 410, the user shards the external secret to be stored in the authoritative blockchain into a number of shards equal to the number of shard managers, although sharding techniques may be used that allow for redundancy such that the secret may be recoverable even in the case where not all shard managers are available.

At 420, the user encrypts each shard with a public key of one shard manager and, at 430, the user submits the encrypted shards to the blockchain in one or more transactions and the encrypted shards are stored on the blockchain after the submitted transaction(s) are validated by the validator nodes.

In some embodiments, the shard manager key pairs may be MPC format keys, such that the shard managers may collaborate to perform signing with the secret, such as upon instruction of the user(s) that stored the secret in the authoritative blockchain, as previously disclosed. This allows for use of the authoritative blockchain authentication mechanisms and policies to control secure signing with the imported external secret, which provides a mechanism for legacy secrets to be used with the security and redundancy of the authoritative blockchain system.

FIG. 4B shows an example process for recovering a key stored via the process of FIG. 4A. At 430, a destination device that will receive the stored secret creates a public/private key pair. At 440, the public key of this pair is sent to the blockchain with sufficient authorizations that it is registered and therefore available to the HSMs as previously disclosed.

At 450, each shard manager decrypts its shard and re-encrypts it using plurality of the user's public keys. These re-encrypted shards are provided to the destination device at 460.

At 470, the destination device(s) may decrypt the shards using its private key and reassemble the shards to obtain the stored secret.

Embodiments disclosed herein also may be used to perform other signing functions. For example, a transaction for an existing public blockchain may be signed using the systems and processes of an authoritative blockchain as disclosed herein. In this example, it is presumed that multiple secrets have already been generated and used to create a multi-signature (“multisig”) address, such as a Bitcoin source address. It is also presumed that a vault object has been created and assigned multiple unspent transaction outputs (UTXOs), thereby giving the vault address a balance in Bitcoins. As previously disclosed, one or more policies may be implemented that control access to, and operation of, the vault object. For example, the policies may require two of three specific registered users to approve any transaction involving the vault. At this point, a transaction may be submitted to the HSM validator nodes that transfers a specific amount of Bitcoin from the source address to a specific destination address using a specific set of UTXOs. Upon receiving the appropriate number of authorizations from the appropriate users, each HSM may generate a signing digest from the transaction information (for example, amount, source and destination addresses, and UTXOs) and signs the digest with its private key.

An entity outside the HSM secure computing environment may collect the signed digests and add them to a conventional Bitcoin multisig transaction. The conventional transaction then may be submitted to the Bitcoin blockchain to be processed. Thus, an entity seeking to audit the Bitcoin transaction may obtain the signed digests and verify that the transaction was processed correctly, with the appropriate authorizations, through the authoritative blockchain system. This may add a layer of security and redundancy to the existing Bitcoin blockchain without requiring any change to operation of the Bitcoin blockchain itself. Similarly, the authoritative blockchain may be used to sign other transactions on any other public, private, or hybrid blockchain systems that may not have the same technical security and redundancy as an authoritative blockchain as disclosed herein. More generally, this functionality may be expanded to other use cases, including any need where a secret must be communicated securely to another secure system, or where cryptographic signing can be utilized, by implementing appropriate signing transactions and key management transactions in the authoritative blockchain. Due to the management of the system by policies and authorization mechanisms that are also controlled by the policies implemented within the system, counterparty-free continuity planning (such as for estate planning or the like) is also made possible by an authoritative blockchain as disclosed herein, while not requiring the single party to trust any one entity with their personal data or secrets.

Notably, in embodiments disclosed herein, use of secrets may be restricted via technological means to only those uses that are authorized or instructed by the user that owns the secret, regardless of the source of the secret (i.e., generated by the authoritative blockchain or an external system). In some embodiments, authorization or instruction may be provided by a user's specified quorum. The secrets are secured by HSMs and policies implemented by the system, such as quorums and the policies for updating policies, as disclosed herein, such that no single operator, administrator, developer, or other entity involved in establishing and maintaining the system can access or affect use of such secrets unless appropriately authorized to do so by the policies implemented in the system.

Embodiments disclosed herein also provide complete HSM lifecycle protection, since a shard manager or other HSM in the system can be securely replaced as previously disclosed if it becomes damaged or otherwise retired from the system.

Embodiments disclosed herein also may provide for operability among multiple blockchains by allowing stored secrets to be securely used in conjunction with other blockchain systems. For example, a validator can enable end users of an authoritative blockchain system as disclosed herein to send and receive currencies between other blockchains (such as, for example, those used to manage Ethereum and Bitcoin cryptocurrencies) without themselves becoming a custodian of the value being transferred. Similarly, embodiments may allow for such transfers among users of the authoritative blockchain without causing the validators to become custodians of the transferred value.

Various embodiments of the presently disclosed subject matter may include, or may be embodied in, computer-implemented processes and apparatuses for practicing those processes. Embodiments also may be embodied in the form of a computer program product having computer program code containing instructions embodied in non-transitory and/or tangible media, such as hard drives, USB (universal serial bus) drives, or any other machine readable storage medium, such that when the computer program code is loaded into and executed by a computer, the computer becomes an apparatus for practicing embodiments of the disclosed subject matter. When implemented on a general-purpose microprocessor, the computer program code may configure the microprocessor to become a special-purpose device, such as by creation of specific logic circuits as specified by the instructions. In some cases, as previously disclosed, limited-purpose, limited-functionality, or specialty hardware may be used. For example, devices such as HSMs and personal identifying devices may include computer-readable media that may store data once and be read many times, but may not be changed after the initial storage. As a specific example, some devices may store a private encryption key and/or associated logic that cannot be changed once written to the device, but which can be read repeatedly.

Embodiments may be implemented using hardware that may include a processor, such as a general-purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter. As noted herein, some devices may include security modules that allow only certain actions to be taken with or on the computing device, such as where a device requires a user to confirm their identity by signing with a private encryption key, which signature can be verified by the device using a corresponding public key.

The foregoing description has been described with reference to specific embodiments for purposes of explanation and ease of illustration. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method of storing secret data on an authoritative blockchain, the method comprising:
receiving a plurality of shards of secret data from a user, the plurality of shards being sufficient to construct the secret data;
encrypting each shard of the plurality of shards with a public key of a public/private key pair to create a ciphertext of the shard, wherein each corresponding private key is known to a shard manager of the blockchain and not known to the user; and
storing each ciphertext on the authoritative blockchain via a transaction submitted to the authoritative blockchain.

2. The method of claim 1, further comprising:
on a destination computing device, creating a recipient public/private key pair;
providing a public key of the recipient public/private key pair to the authoritative blockchain;
decrypting, by each shard manager and using the private key of the public/private key pair of the shard manager, a ciphertext of the secret data that was generated using the corresponding public key of the public/private key pair of the shard manager and a shard of the secret data to obtain the shard of the secret data;
encrypting, by each shard manager and with the public key of the recipient public/private key pair, the shard of the secret data; and
providing, by each shard manager to the destination computing device, the shard of the secret data encrypted with the public key of the recipient public/private key pair.

3. The method of claim 2, wherein providing the public key to the authoritative blockchain comprises receiving authentication data for a known user of the authoritative blockchain sufficient to register the public key with the blockchain and thereby make the public key available for use by one or more security hardware modules that approve transactions on the authoritative blockchain.

4. The method of claim 2, wherein providing the public key to the authoritative blockchain comprises providing the public key to one or more HSMs in an approved transaction submitted for inclusion on the blockchain.

5. The method of claim 2, further comprising, by the destination computing device:
receiving, from each shard manager, the shard of the secret data generated by the shard manager by encrypting the shard of the secret data with the public key of the recipient public/private key pair;
decrypting each shard received from the each shard manager to obtain a shard of the secret data; and
combining all shards of the secret data to generate the secret data.

6. The method of claim 1, further comprising decrypting, by each shard manager and using the private key of the public/private key pair of the shard manager, a ciphertext of the secret data that was generated using the corresponding public key of the public/private key pair of the shard manager and a shard of the secret data to obtain the shard of the secret data;
combining, by a computerized management system of the authoritative blockchain, the shards of the secret data decrypted by the shard managers to generate the secret data; and
using the secret data, signing a transaction on behalf of the user.

7. A method of storing an external secret on an authoritative blockchain, the method comprising:
generating an import public/private key pair;
receiving, by the blockchain, an import transaction comprising secret data encrypted with the public key of the import public/private key pair; and
adding the import transaction to the blockchain.

8. The method of claim 7, further comprising, prior to the step of adding the import transaction to the blockchain, verifying, by a plurality of computerized validator nodes associated with the authoritative blockchain, the encrypted secret using the private key of the import public/private key pair.

9. The method of claim 7, further comprising:
receiving, by the authoritative blockchain from a requestor, a retrieval transaction specifying the secret data is to be retrieved;
decrypting, by a secure hardware module of the authoritative blockchain and using the private key of the import public/private key pair, the encrypted secret;
encrypting the secret data with a public key of a secure digital vault to which the secret data is to be provided according to the retrieval transaction; and
providing the secret data encrypted with the public key of the secure digital vault to the requestor or to the secure digital vault.

10. The method of claim 7, wherein the retrieval transaction is generated in response to an approval to retrieve the secret data from the authoritative blockchain by a quorum of users.

11. The method of claim 10, further comprising:
receiving, by the authoritative blockchain, an approval transaction from each of the quorum of users, the approval transaction identifying the secret data.

12. A system for implementing an authoritative blockchain, comprising:
a plurality of groups of HSMs, each group comprising one or more HSMs, each group operated and controlled by an independent validator entity, wherein each validator entity is separate and distinct from each other validator entity;
a plurality of instructions encoded in each HSM in each group of HSMs that govern operation of the HSMs and specify criteria for use of data stored on the authoritative blockchain, wherein each validator entity is unable to access secret data stored according to the plurality of instructions on the respective HSMs operated and controlled by the each validator entity.

13. The system of claim 12, wherein each HSM is configured to store a secret data by:
receiving a shard of secret data encrypted with a public key corresponding to a private key of the HSM; and
storing the shard of secret data encrypted with the public key on the authoritative blockchain via a transaction submitted to the authoritative blockchain.

14. The system of claim 13, wherein the secret data cannot be reconstructed from fewer than a predefined quorum of shards.

15. The system of claim 14, wherein no shard of the secret data is encrypted with the same public key as any other shard of the secret data.

16. The system of claim 13, wherein each group of HSMs provides high-availability redundancy to each other group of HSMs.

17. The system of claim 13, wherein, within each group of HSMs, one or more HSMs provides high-availability redundancy to at least one other HSM in the same group.

18. The system of claim 12, wherein:
each HSM is further configured to decrypt, using the private key of the each HSM, a ciphertext of the secret data that was generated using the corresponding public key of the public/private key pair of the HSM and a shard of the secret data to obtain the shard of the secret data; and
a computerized management system of the authoritative blockchain is configured to combine the shards of the secret data decrypted by the HSMs to generate the secret data and to sign a transaction on behalf of the user after receiving an instruction to do so from the user and verifying the instruction is valid and originates from the user.
